(19) United States
(12) Patent Application Publication
(10) Pub. No.: US 2017/0091572 A1
(43) Pub. Date: Mar. 30, 2017

(54) System And Method For Text Detection In An Image

(71) Applicant: Apple Inc., Cupertino, CA (US)

(72) Inventors: Lars M. Lindberg, Los Altos, CA (US); Leo Barnes, Cupertino, CA (US); Anders M. Holtsberg, Los Gatos, CA (US)

(21) Appl. No.: 14/870,677

(22) Filed: Sep. 30, 2015

(51) Int. Cl. G06K 9/34; G06K 9/46

(52) U.S. Cl. CPC G06K 9/342; G06K 9/4638; G06K 2209/011; G06K 2009/4666

(57) ABSTRACT

The present disclosure relates to image processing and analysis and, in particular, automatic detection of text in an image through an application or an application program interface. In some embodiments, text is detected, but not recognized, through a process including: binarization or trinarization of an image; blob detection of the binarized or trinarized image; grouping blobs into horizontal boundaries; and using statistics to determine that some of horizontal bounded blobs are not text.

### CROSS-REFERENCE TO RELATED APPLICATIONS

This patent application claims priority to provisional patent application No. 62/172,117, filed Jun. 7, 2015, which is hereby incorporated by reference in its entirety.

### BACKGROUND

Over the past two decades, cameras have become very common devices to own and use around the world. For example, the advent of portable integrated computing devices has caused a wide proliferation of cameras. These integrated computing devices commonly take the form of smartphones or tablets and typically include general purpose computers, cameras, sophisticated user interfaces including touch sensitive screens, and wireless communications abilities through Wi-Fi, LTE, HSDPA, and other cell-based or wireless technologies. The wide proliferation of cameras including those in these integrated devices provides opportunities to use the devices' capabilities to take pictures and perform imaging related tasks very regularly. Contemporary integrated devices, such as smartphones and tablets, typically have one or two embedded cameras. These cameras generally amount to lens/camera hardware modules that may be controlled through the general purpose computer using downloadable software (e.g., “Apps”) and a user interface including the touch-screen fixed buttons and touchless controls, such as voice control.

One opportunity for using the features of an integrated device (or a contemporary camera device) is to capture and evaluate images. A resident camera allows the capture of one or more images and an integrated general-purpose computer provides processing power to perform analysis on the captured images. In addition, any analysis that is preferred for a network service computer can be facilitated by simply transmitting the image data or other data to a service computer (e.g., a server, a website, or other network-accessible computer) by using the communications capabilities of the device.

These abilities of integrated devices allow for recreational, commercial, and transactional uses of images and image analysis. For example, images may be captured and analyzed to decipher information from the images, such as readable text, characters, and symbols. The text, characters, and symbols may be transmitted over a network for any useful purpose, such as for use in a game, a database, or as part of a financial transaction. For these reasons and others, it is useful to enhance the abilities of these integrated devices and other devices for efficiently deciphering from images any regions containing text, characters, or any meaningful symbol information.

### SUMMARY

Some images contain text, characters, or other decipherable symbols that could be useful if those characters or symbols were directly accessed by a computer in the manner that, for example, an ASCII character may be accessed. In discussing embodiments herein, the term “text” may be used to represent all types of communicative characters, such as all types of alphabets and symbols, including Japanese, Chinese, Korean, and alphabets of other languages. Some embodiments of this disclosure seek to enhance a computer's ability to quickly and efficiently detect text that is visibly embodied in images. Further, by using an integrated device, such as a smartphone or tablet, a user may capture an image, have the image processed to detect text, and then use the deciphered information for general computing purposes (e.g., OCR the detected text and employ it in a local or web-based application, such as gaming; utility, such as augmented reality; office productivity, such as word processing or spreadsheets; or transactions, such as financial transactions).

One example of using an integrated device having a camera and a reasonably capable computer is to capture an image or rapid sequence of images and detect the presence of text on the fly, as images are captured. In other embodiments, images may be captured separately from the application of text detection as discussed herein. For example, in addition to being relatively simultaneous, image capture and text detection may be temporally separated, logically separated, and/or geographically separated (e.g., capture on a local device and text detection on a network/internet connected computer resource, such as a server).

Many embodiments of the disclosure are initiated with the capture or receipt of image information, such as a color or black and white image. Depending upon the embodiment, each received or captured image may be binarized or trinarized, meaning that the pixels (or other components) of the image may be categorized in two or three different ways. For example, in a binarized embodiment, each pixel may be represented as either black or white, depending upon the original status of the pixel. In a trinarized embodiment, each pixel may be categorized as black, white, or gray, where gray represents a pixel (or other component) that has been determined to not comprise or be comprised of text. In some embodiments, the trinarized example may be more efficient because the gray pixels may be eliminated from further text-related analysis.

After an image (or part thereof) has been binarized or trinarized, some embodiments of the invention attempt to identify blobs, which may, for example, be connected components of common color (e.g., the connected black pixels and the connected white pixels). In some embodiments, after blobs are detected, the resulting image may be described as gray area and a collection of blobs or connected components. Furthermore, once a plurality of blobs has been identified, some embodiments of the disclosure seek to group blobs or connected components into horizontal sequences. Moreover, the horizontal sequences may be found in either a top down or bottom up process (i.e., by starting with large sequences of blobs and working toward smaller sequences, or by starting with smaller sequences, such as one or two sequential blobs, and working up to larger sequences). Finally, after one or more horizontal sequences has been identified, a series of statistical tests may be applied to each sequence and/or blob to determine if the sequence or blob does not include text. After this elimination process, in some embodiments, any remaining sequences are determined or presumed to be detected text (although not necessarily recognized text). By performing the analysis without engaging in OCR or any glyph recognition, the invention is able to detect text in any alphabet, so it is very useful globally.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a block diagram of an illustrative hardware device.

FIG. 2 is a system diagram illustrating a potential network environment.

FIG. 3 is layer diagram illustrating a potential organization of software components.

FIG. 4 shows a process associated with embodiments of the disclosure.

FIG. 5 shows another process illustrating certain embodiments of the disclosure.

FIGS. 6A through 6H illustrate a group of pixels and data structures in an analysis of the pixels.

FIGS. 7A through 7C illustrate a received image and stages of processing the received image in accordance with some embodiments of the disclosure.

FIGS. 8A and 8B illustrate a received image and a stage of processing the received image in accordance with some embodiments of the disclosure.

### DETAILED DESCRIPTION

The inventive embodiments described herein may have implication and use in all types of cameras and in single- and multi-processor computing systems or devices including any type of camera. The discussion herein references a common computing configuration having a CPU resource including one or more microprocessors. The discussion is only for illustration and is not intended to confine the application of the invention to the disclosed hardware. Other systems having other known or common hardware configurations are fully contemplated and expected. With that caveat, a typical hardware and software operating environment is discussed below. The hardware configuration may be found, for example, in a camera device; a phone; or any computing device, such as a portable computing device comprising a phone and/or a computer and/or a camera.

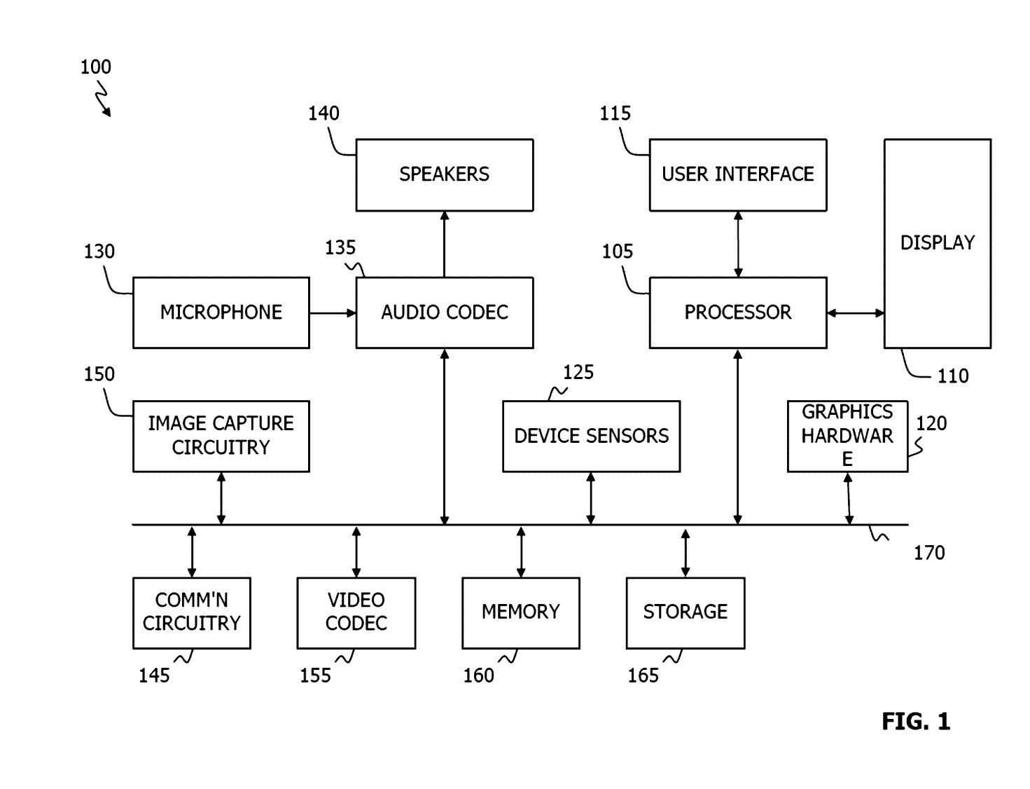

Referring to FIG. 1, a simplified functional block diagram of illustrative electronic device 100 is shown according to one embodiment. Electronic device 100 could be, for example, a mobile telephone, personal media device, portable camera, a tablet, notebook, or desktop computer system, or even a server. As shown, electronic device 100 may include processor 105, display 110, user interface 115, graphics hardware 120, device sensors 125 (e.g., depth sensor, LIDAR, proximity sensor/ambient light sensor, accelerometer and/or gyroscope), microphone 130, audio codec(s) 135, speaker(s) 140, communications circuitry 145, digital image capture unit (e.g., camera) 150, video codec(s) 155, memory 160, storage 165, and communications bus 170. Communications circuitry 145 may include one or more chip sets for enabling cell based communications (e.g., LTE, CDMA, GSM, HSDPA, etc.) or other communications (Wi-Fi, Bluetooth, USB, Thunderbolt, Firewire, etc.). Electronic device 100 may be, for example, a personal digital assistant (PDA), a personal music player, a mobile telephone, a notebook, a laptop, a tablet computer system, or any desirable combination of the foregoing.

Processor 105 may execute instructions necessary to carry out or control the operation of many functions performed by device 100 (e.g., such as the generation and/or processing and/or evaluation and analysis of media, such as images). In general, many of the functions described herein are based upon a microprocessor acting upon software (instructions) embodying the function. Processor 105 may, for instance, drive display 110 and receive user input from user interface 115. User interface 115 can take a variety of forms, such as a button, a keypad, a dial, a click wheel, a keyboard, a display screen and/or a touch screen, or even a microphone or camera (video and/or still) to capture and interpret input sound/voice or images, including video. The user interface 115 may capture user input for any purpose, including for use as images or instructions to capture images or instructions to the system for any other function.

Processor 105 may be a system-on-chip, such as those found in mobile devices, and may include a dedicated graphics processing unit (GPU). Processor 105 may be based on reduced instruction-set computer (RISC) or complex instruction-set computer (CISC) architectures or any other suitable architecture and may include one or more processing cores. Graphics hardware 120 may be special purpose computational hardware for processing graphics and/or assisting processor 105 to process graphics information. In one embodiment, graphics hardware 120 may include one or more programmable GPUs.

Image capture circuitry 150 may capture still and video images that may be processed to generate images for any purpose. including to be analyzed to detect text, characters. and/or symbols in accordance with the teachings described herein. Output from image capture circuitry 150 may be processed, at least in part, by video codec(s) 155 and/or processor 105 and/or graphics hardware 120 and/or a dedicated image processing unit incorporated within image capture circuitry 150. Images so captured may be stored in memory 160 and/or storage 165 and/or in any storage accessible on an attached network. Memory 160 may include one or more different types of media used by processor 105, graphics hardware 120, and/or image capture circuitry 150 to perform device functions. For example, memory 160 may include memory cache, electrically erasable memory (e.g., flash), read-only memory (ROM), and/or random access memory (RAM). Storage 165 may store media (e.g., audio, image, and video files); computer program instructions; or other software, including database applications, preference information, device profile information, and any other suitable data. Storage 165 may include one more non-transitory storage media, including, for example, magnetic disks (fixed, floppy, and removable) and tape; optical media, such as CD-ROMs and digital video disks (DVDs); and semiconductor memory devices, such as Electrically Programmable Read-Only Memory (EPROM) and Electrically Erasable Programmable Read-Only Memory (EEPROM). Memory 160 and storage 165 may be used to retain computer program instructions or code organized into one or more modules and written in any desired computer programming language. When executed by, for example, processor 105, such computer program code may implement one or more of the methods or functions described herein.

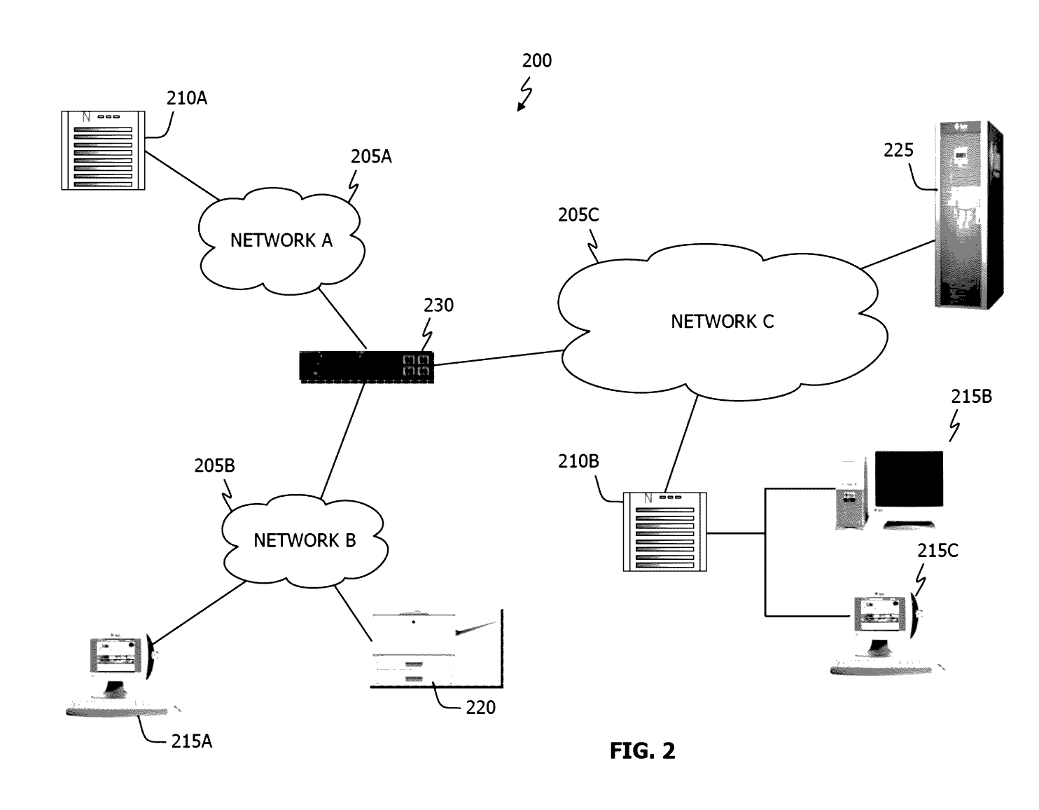

Referring now to FIG. 2, illustrative network architecture 200, within which the disclosed techniques may be implemented, includes a plurality of networks 205, (i.e., 205A, 205B and 205C), each of which may take any form including, but not limited to, a local area network (LAN) or a wide area network (WAN), such as the Internet. Further, networks 205 may use any desired technology (wired, wireless, or a combination thereof) and protocol (e.g., transmission control protocol, TCP). Coupled to networks 205 are data server computers 210 (i.e., 210A and 210B) that are capable of operating server applications, such as databases, and are also capable of communicating over networks 205. One embodiment using server computers may involve the operation of one or more central systems to collect, process, and distribute information to and from mobile computing devices, such as smart phones or network-connected tablets. For example, in some embodiments, images may be captured or otherwise received by user devices, after which those images may be analyzed or processed by one or more network-accessible servers.

Also coupled to networks 205, and/or data server computers 210, are client computers 215 (i.e., 215A, 215B and 215C), which may take the form of any computer, set top box, entertainment device, communications device or intelligent machine, including embedded systems. In some embodiments, users may employ client computers in the form of smart phones, tablets, laptops, or other computers. In some embodiments, network architecture 200 may also include network printers, such as printer 220, and storage systems, such as 225, which may be used to store multi-media items (e.g., images) that are referenced herein. To facilitate communication between different network devices (e.g., data servers 210, end-user computers 215, network printer 220, and storage system 225), at least one gateway or router 230 may be optionally coupled therebetween. Furthermore, in order to facilitate such communication, each device employing the network may comprise a network adapter. For example, if an Ethernet network is desired for communication, each participating device must have an Ethernet adapter or embedded Ethernet capable ICs. Further, the devices must carry network adapters for any network in which they will participate.

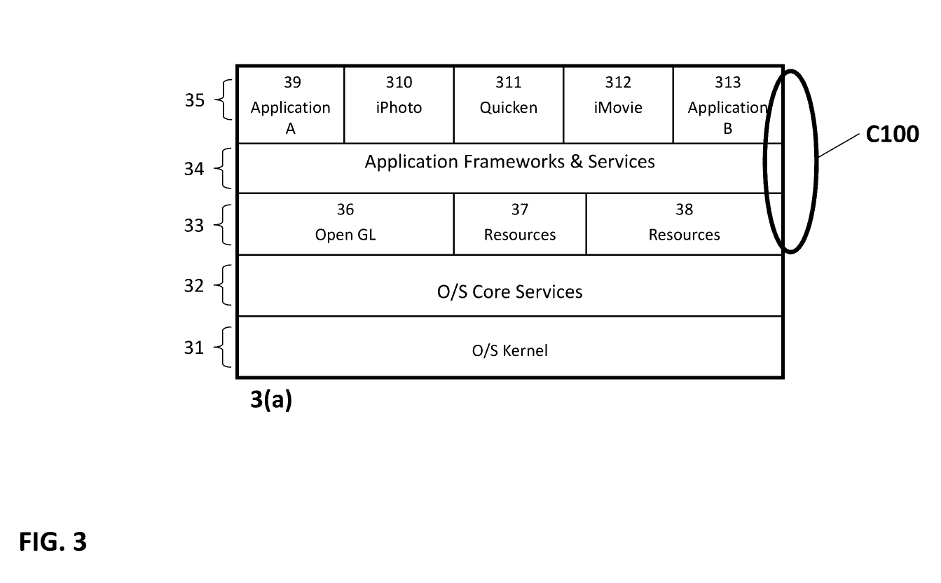

As noted above, embodiments of this disclosure include software. As such, a general description of common computing software architecture is provided as expressed in the layer diagrams of FIG. 3. Like the hardware examples, the software architecture discussed here is not intended to be exclusive in any way, but rather illustrative. This is especially true for layer-type diagrams, which software developers tend to express in somewhat differing ways. In this case, the description begins with layers starting with the O/S kernel so lower level software and firmware has been omitted from the illustration, but not from the intended embodiments. The notation employed here is generally intended to imply that software elements shown in a layer use resources from the layers below and provide services to layers above. However, in practice, all components of a particular software element may not behave entirely in that manner.

With those caveats regarding software, referring to FIG. 3, layer 31 is the O/S kernel, which provides core O/S functions in a protected environment. Above the O/S kernel, there is layer 32 O/S core services, which extends functional services to the layers above, such as disk and communications access. Layer 33 is inserted to show the general relative positioning of the Open GL library and similar resources, such as Apple's Metal library. Layer 34 is an amalgamation of functions typically expressed as multiple layers: applications frameworks and application services. For purposes of our discussion, these layers provide high-level and often functional support for application programs that reside in the highest layer, shown here as item 35. Item C100 is intended to show the general relative positioning of the software, including any client side software described for some of the embodiments of the current invention. While the ingenuity of any particular software developer might place the functions described herein at any place in the software stack, the software hereinafter described is generally envisioned as either user facing (e.g., in a user application, such as a camera application) and/or as a resource for user-facing applications to employ functionality related to text detection. In particular, some embodiments of the disclosure provide for text detection through application program interfaces, thus these embodiments might reside in layers such as 34 and 35. Other embodiments may provide application level access (e.g., user access) to text detection functionality, thus residing for example in layer 35. On the server side, certain embodiments described herein may be implemented using server application level software, database software, either possibly including frameworks and a variety of resource modules.

No limitation is intended by these hardware and software descriptions and the varying embodiments of the inventions herein may include any manner of computing device, such as Macs, PCs, PDAs, phones, servers, or even embedded systems.

A Text Detector

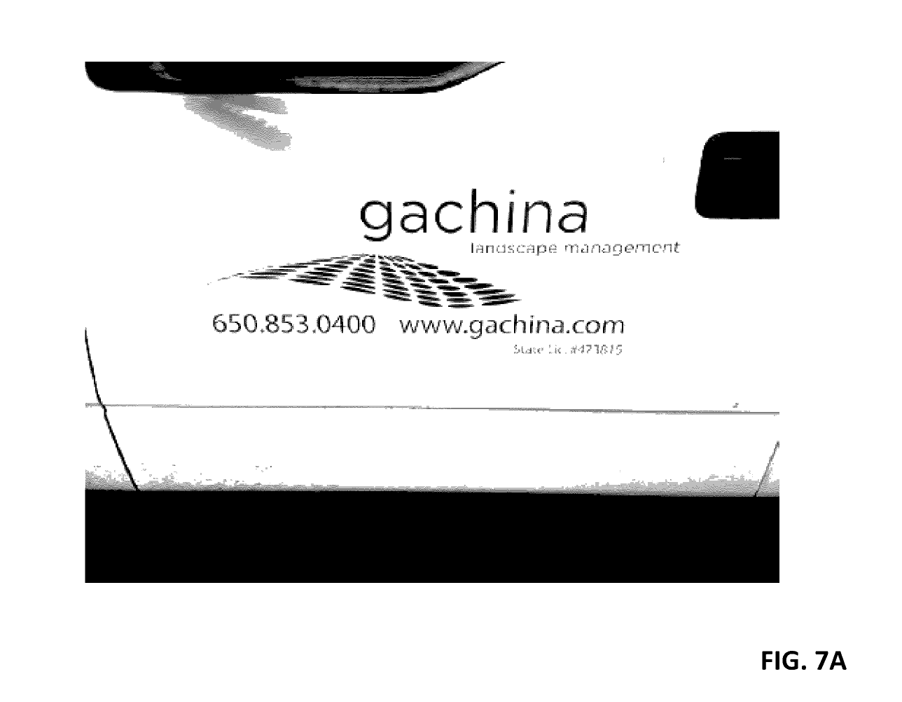

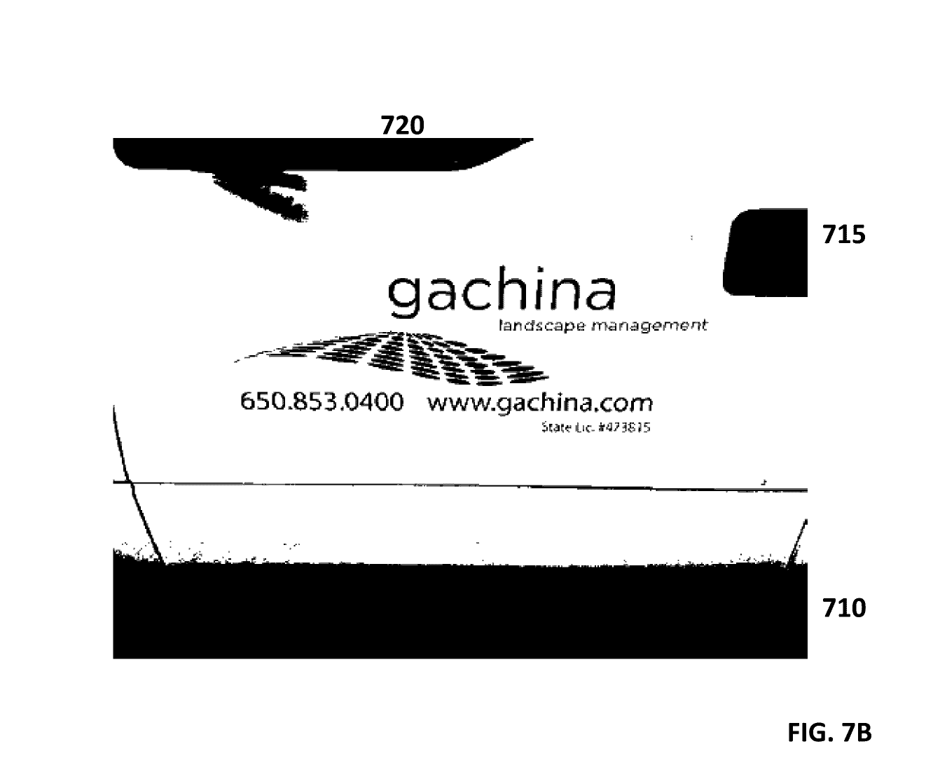

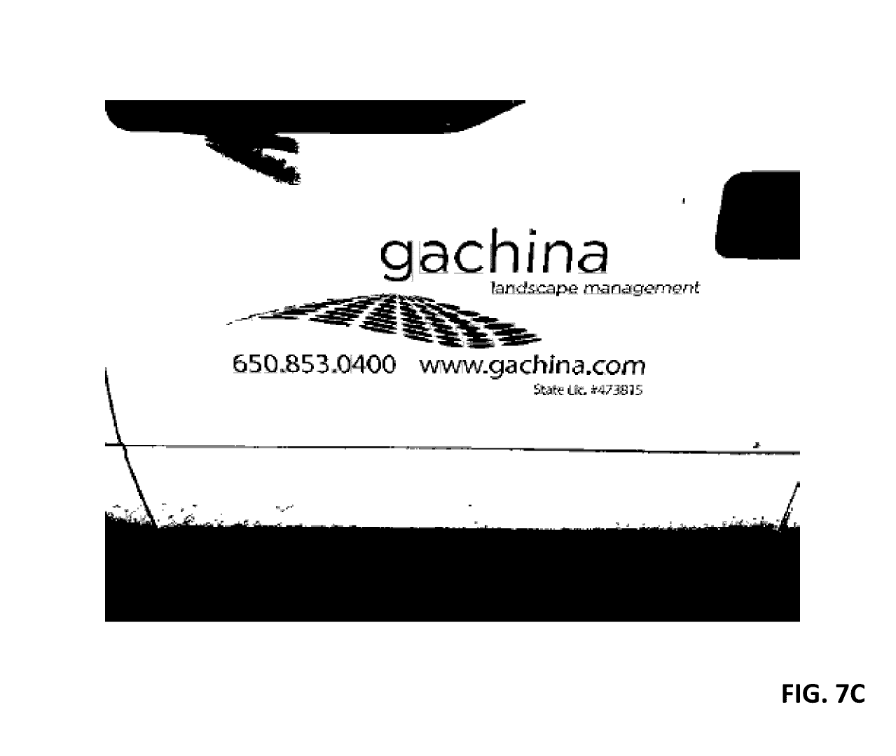

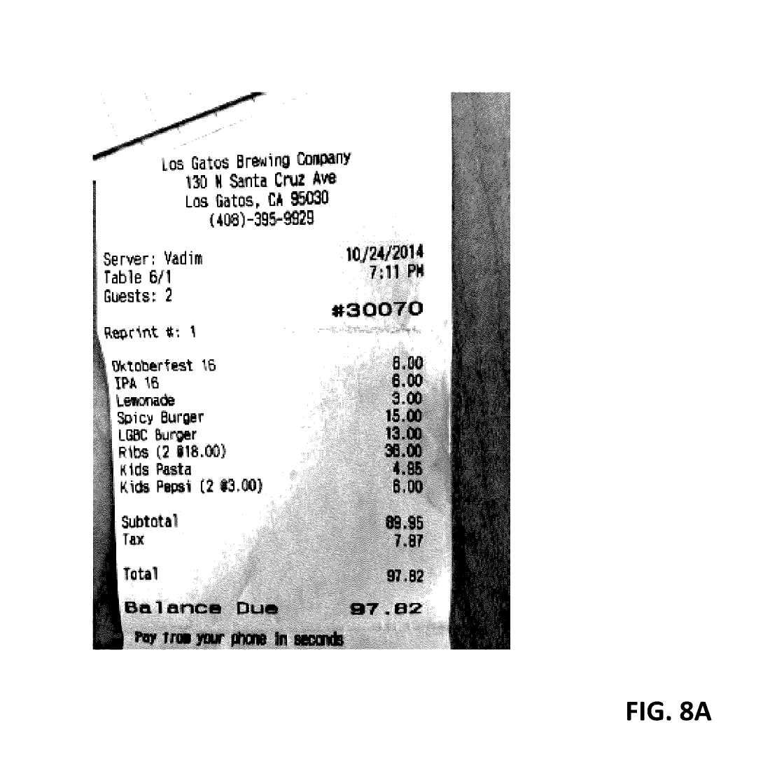

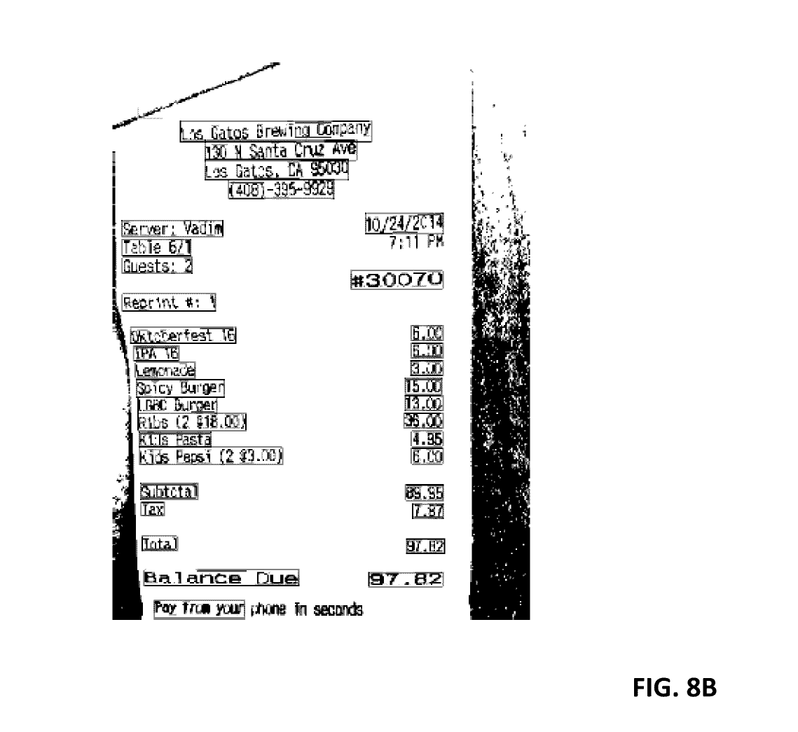

Many embodiments of the disclosure contemplate a text detector for detecting the presence of text in an image or image information. Examples of images containing text are shown in FIGS. 7A and 8A. The image of FIG. 7A, for example, is a picture of a car door carrying marketing text. In some embodiments, the text detector is made available to application software as a framework or private framework. For example, an application program may use a well-defined interface to detect the presence of text and the location of text in an image or image information. In two specific embodiments, the text detector is a framework in Apple iOS and/or Apple OS X, and it is exposed to third party developers as an Apple Core Image detector called CIDetectorTypeText. At the time of this writing, Apple Core Image currently has three other detectors: CIDetectorTypeFace, CIDetectorTypeRectangle, CIDetectorTypeQRCode. As contemplated by various embodiments of this disclosure, a detected text feature may consist of a horizontal bounding box as well as the coordinates of the four corners of the bounding box (since text may be slanted). While these specific embodiments in Apple products expose the interface through certain current frameworks, it may also be exposed through other existing frameworks (e.g., AVFoundation) or not-yet existing frameworks. In addition, the concept of making text detection available through an API may be implemented on any system (Apple or non-Apple) and in any way used to implement a framework, whether currently known or unknown.

A Process for Text Detection

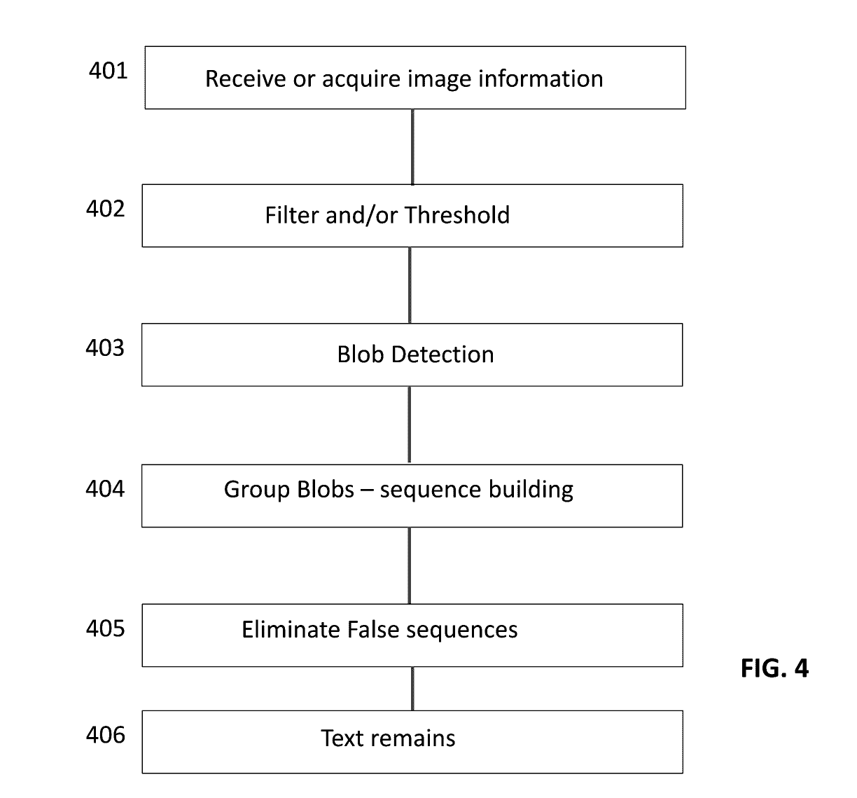

Referring to FIG. 4, there is shown a process for text detection that may operate on any of the intelligent systems discussed above. In some embodiments, the process operates on a smartphone, tablet, or computer that integrates a camera with a general-purpose computer. In one or more embodiments, the process may be implemented through a framework such that an application like a camera application or image-viewing application may use an API to request the identification of text areas in designated image information. For example, a camera application may request real-time text identification as it simultaneously engages in capturing a sequence of images. As another example, a photo organizing and viewing application may request real-time text detection when a user views, edits or organizes a photo.

Referring to FIG. 4, at 401 an image or image information is received. The image may be received through capture by a camera, receipt over a network, receipt of a pointer to memory, or by any other known way to receive an image. In some embodiments, the received image information may be a color image, a gray scale image, or a pure black and white image. Differing embodiments of the disclosure contemplate receiving the image in any form known to the software (e.g., JPEG, GIF, RAW, etc.).

Referring again to FIG. 4, at 402, the image is filtered and/or processed (e.g., by subjecting to a threshold) to create regions for further processing. In some embodiments, each pixel or portion of the image is identified or converted to black or white. In other embodiments, each pixel or portion of the image is identified or converted into one of three categories: black, white, and gray (where gray indicates a determination that the pixel or portion may not or does not comprise text and/or may not be comprised of text). An example of a converted image is shown in FIG. 7B.

In one embodiment pertaining to 402, if the input image is not grayscale, it is transformed to an image where pixels are represented as YCbCr. For example, pixels may be converted from RGB values to YCbCr values. In one or more embodiments, the chroma values (Cb and Cr) may be ignored and filtering and/or thresholds may be applied only with respect to the luma channel (Y), which represents a grayscale image. In some embodiments, the chroma value may be used to refine the filtering/threshold-applied results. For example, chroma values may be used to: categorize pixels in more ways than luma will allow or to make a categorization decision about a pixel that is uncertain or less certain with reference only to the luma value.

In some embodiments, item 402-threshold application includes binarization or trinarization of the image pixels or portions. Binarization transforms the image by representing each pixel or portion in one of only two states, such as black and white. If the image of FIG. 7B is used as an example, there are two types of regions, black and white. Trinarization transforms the image by representing each pixel or portion in one of only three states, such as black white, and gray. The use of gray may be either literal (e.g., representing a pixel in a gray color) or figurative (e.g., where, regardless of the visible color, pixels are associated with “gray”). In some embodiments, use of gray in association with a pixel indicates that the pixel has been determined as not relating to text. In one or more embodiments, gray pixels may be identified as pixels in a region having very little contrast. For example, in FIG. 7B, the essentially black regions labeled as 710, 715, and 720 have little or no contrast so software may determine (perhaps sub-part at a time) that the pixels in these regions should be associated with gray because they will not contain text.

Adaptive Block Based Process

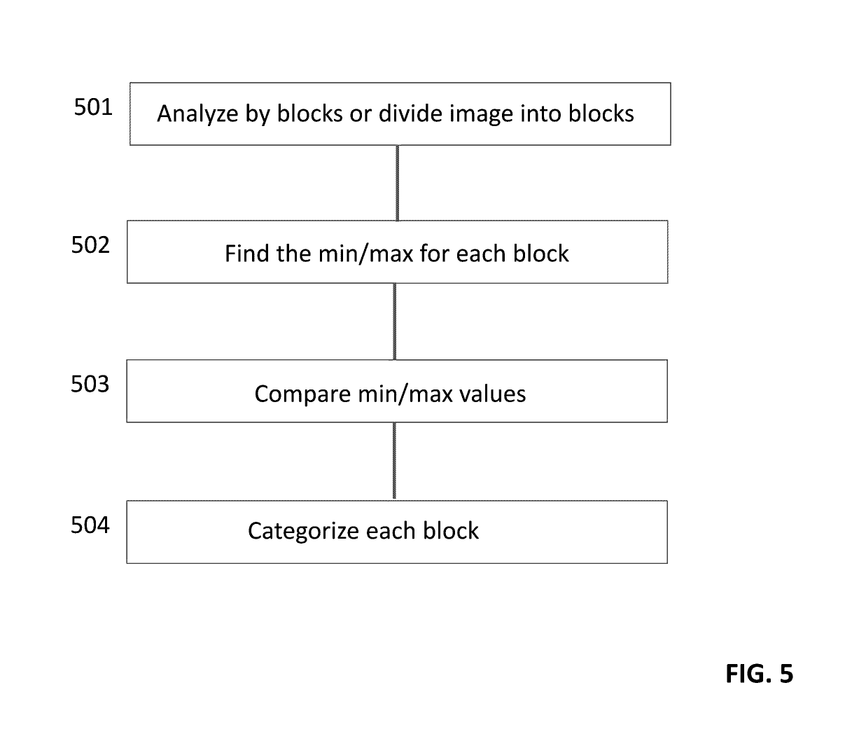

In some embodiments, the result of binarization/trinarization is to remove effects like uneven illumination, shadows, shifted white-levels, and similar effects. One particular embodiment employs a locally-adaptive block-based algorithm with partially overlapping blocks. An example of this embodiment is shown in FIG. 5. Referring to FIG. 5, binarization or trinarization may occur under the process shown. At 501, an image may be divided into blocks or pixels or portions. Similarly, whether or not literally divided into blocks, an image may be analyzed in block-size regions, or pixel by pixel, or by any size portions. In one embodiment, blocks consist of regions of 32×32 pixels, thus an image may be partitioned into blocks of 32×32 pixels or analyzed in blocks of the same size. In other embodiments, and possibly depending upon the resolution of the image, more or less pixels may be chosen (e.g., more pixels for higher resolution and less pixels for lower resolution).

Referring again to FIG. 5, at 502 a minimum and maximum pixel value are determined for each block. In some embodiments, the minimum and maximum values reflect the contrast within a block so the values may be assessed as a luma value for each pixel or portion of the block. Since the minimum/maximum assessment relates to a determination of contrast, some embodiments may use direct information regarding contrast within a block. Of course, any other mechanism may be used to assess a pixel or portion and its comparative contrast to other pixels or portions in a block. In one or more embodiments, the minimum and maximum for each block is assessed by first expanding the block to include neighboring pixels or image portions, and such that the minimum/maximum assessment is performed in a fashion that overlaps neighboring blocks (e.g., when a block is assessed for minimum/maximum, it is expanded to overlap with neighboring blocks). In some embodiments, the blocks are expanded by approximately 50-60%. For example, in the instance of 32×32 blocks, some embodiments expand the block by 4 pixels on each side, resulting in a 40×40 block for purposes of determining minimum/maximum values for each block.

Referring again to FIG. 5, the minimum and maximum values of each block are compared. In some embodiments, the comparison determines a difference between the values that reflects contrast. In other embodiments, other comparison techniques may be used to reflect the contrast difference between the minimum and maximum values. In one or more embodiments, a threshold is used to compare minimum and maximum values. For example, if the difference between minimum and maximum values is less than a first threshold, at 504, the block may reflect low contrast and may be categorized as a gray area. In some embodiments, gray blocks are determined to not include text because there is too little contrast for text to be present. In one or more embodiments, the first threshold is 48.

In some embodiments, if the difference between minimum and maximum is larger than a second threshold (which may be equal to the first threshold), then each pixel or portion in the block may be evaluated/categorized as black or white. Following the example from above, if the minimum/maximum difference is 48 or above (or above a threshold), some embodiments may set a black point and evaluate each pixel in the block with respect to the black point. For example, any pixel with a value less than the black point may be classified as black, and any pixel with a value larger than the black point may be classified as white. In one or more embodiments, the black point is determined individually for each block. In addition, in some embodiments, the black point for a block may be (minimum+maximum)/2 or some other function of the minimum and maximum values.

After each block and/or pixel and/or portion in an image has been evaluated according to FIG. 5, an output image is trinarized so that every pixel is white, black, or gray (e.g., all pixels in a gray block may be categorized as gray). A trinarized image may appear similar to the image in FIG. 7B (where gray is represented figuratively), or may show gray pixels literally.

Referring back to FIG. 4, after image pixels/portions have been categorized (e.g., binarized or trinarized), they may be subjected to 403 blob detection. In one embodiment, blob detection locates and/or identifies groups of neighboring pixels that are the same color. Since the input image may already be binarized or trinarized at this point in the process, some embodiments are limited to grouping in three colors: black, white, and gray. However, since some embodiments eliminate gray pixels as candidates for text, blob detection may only relate to black and white pixels.

Connected Component Builder

In some embodiments, blob detection 403 involves a connected component builder. In some embodiments, the connected component builder uses a trinarized or binarized image as discussed above for its input. The connected component builder may build groups of like pixels for black and/or white and/or gray pixels. In some embodiments, connected components are identified in one program pass through the pixels or portions, meaning that all pixels are swept through once before a result is achieved (e.g., the components are identified, related, and labeled if necessary in one pass).

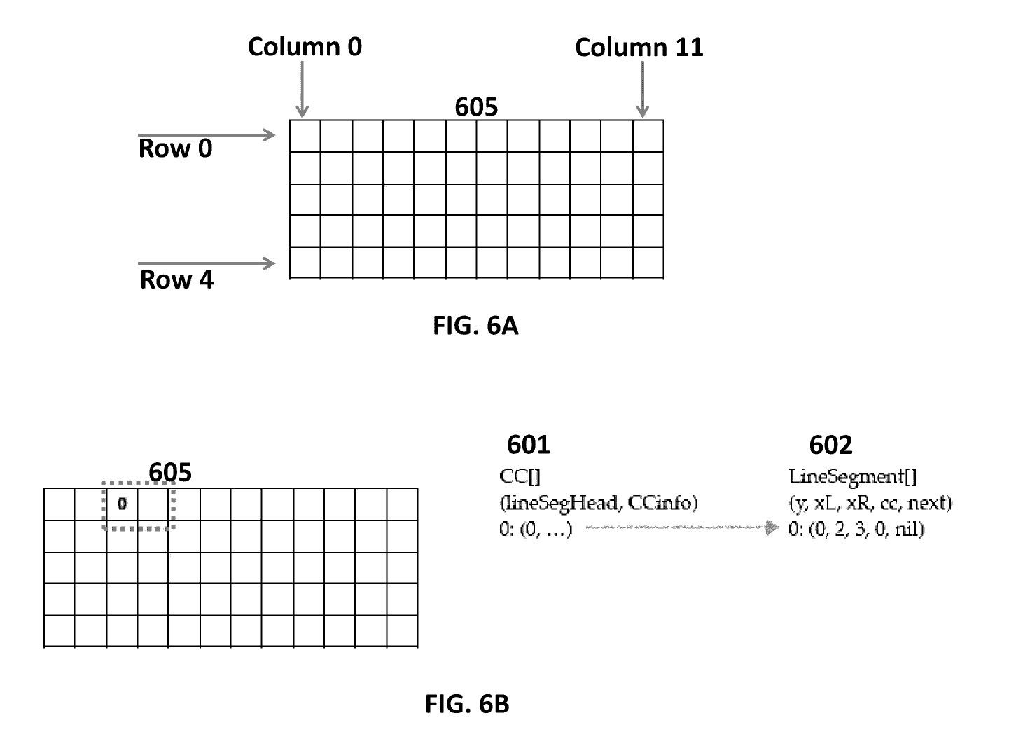

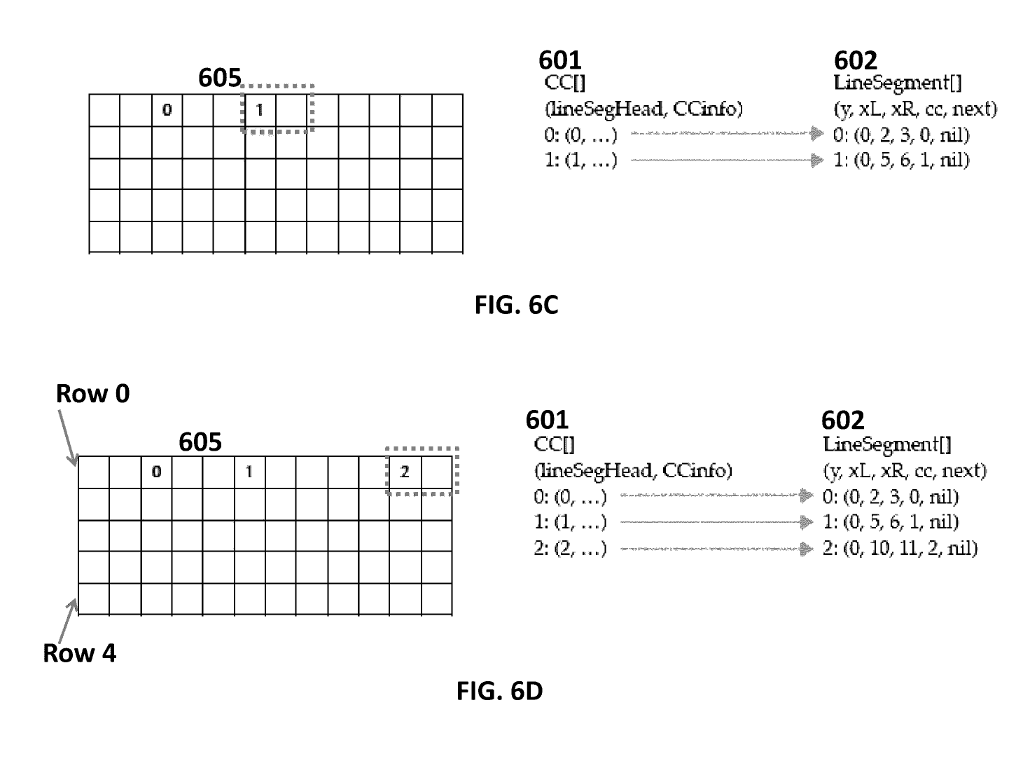

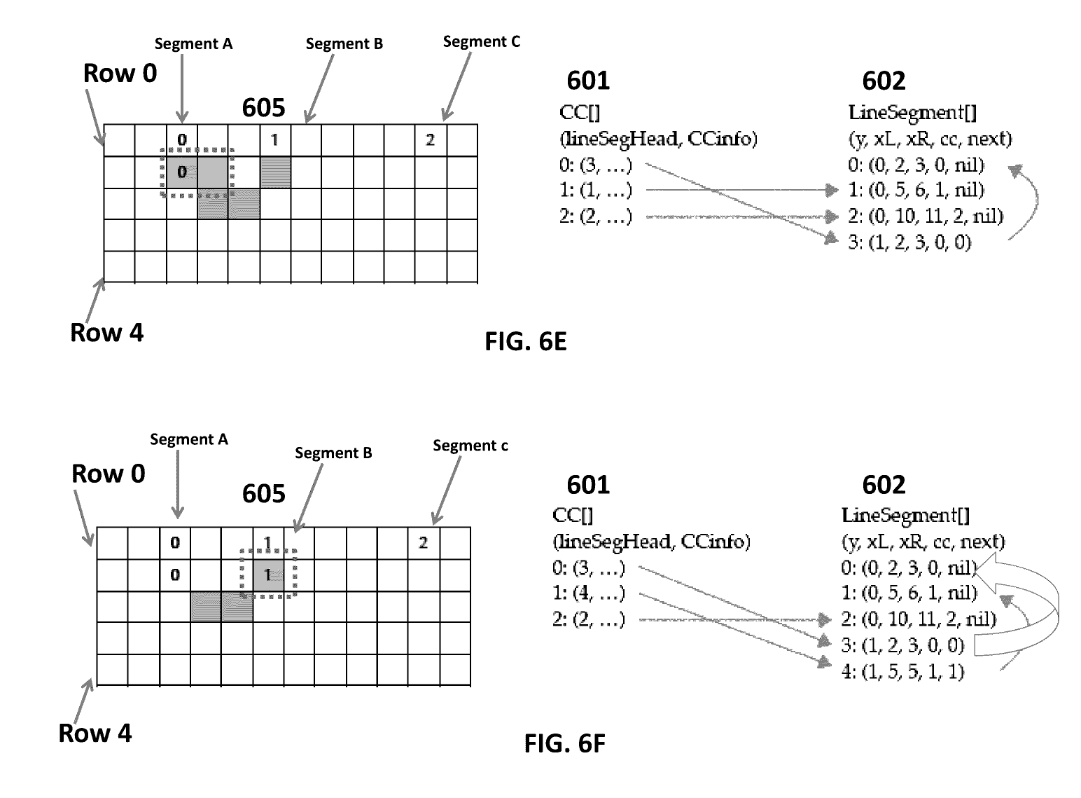

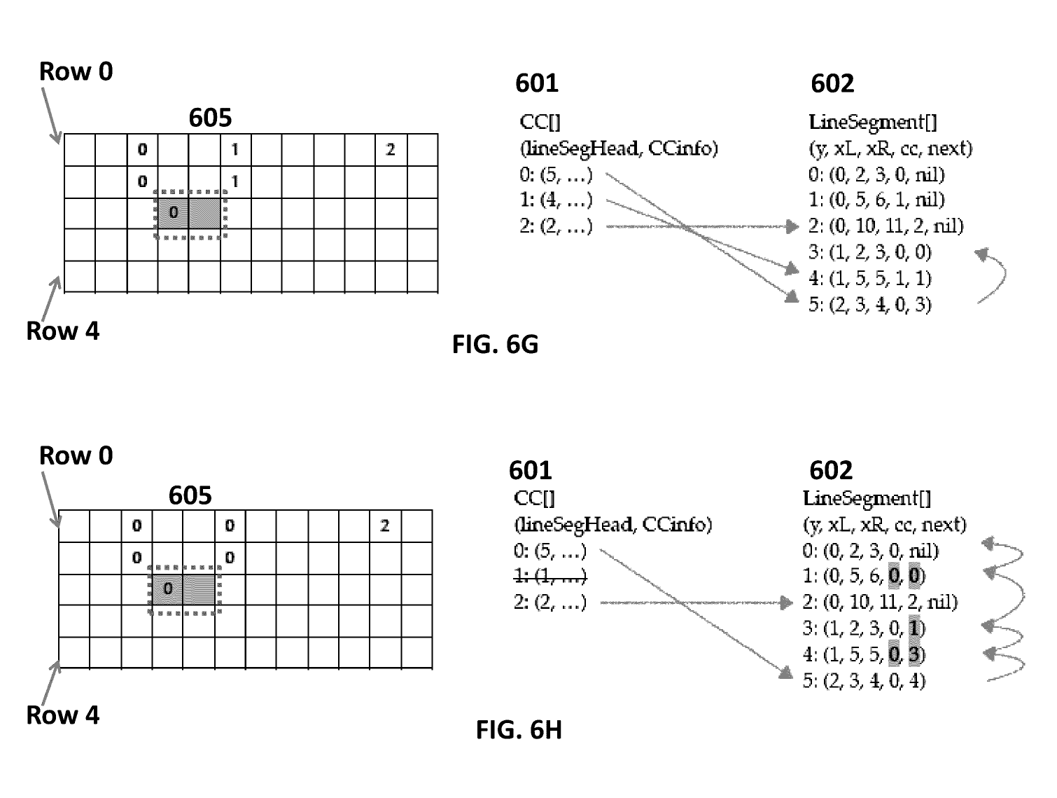

A group of contemplated embodiments for a connected component builder are shown in FIGS. 6A through 6H. With reference to FIG. 6A, there is shown a group of connected pixels 605, each pixel represented by one square in the figure. In FIG. 6A, the pixels 605 are shown binarized such that the darker shaded pixels (shown in blue) may represent black and the lighter pixels (shown in white) may represent white. The representation of FIGS. 6A (and 6B through 6H) uses a binary format for illustration only and it should be understood that varying embodiments may represent pixels through trinarization and thereby have three or more colors or categories. However, for the purpose of illustrating an embodiment of a connected component builder, these examples illustrate building components in a single color/category—black. Other embodiments, which are not shown in the diagram, may simultaneously build connected components in two, three, or more colors.

Referring now to FIG. 6B, there is shown the same pixels 605 along with data structures regarding detected connected components 601 and line segments 602. In some embodiments, the data structures 601 and 602 will, after processing, represent all the connected components and line segments identified in the image (and in some embodiments, after only one program pass through the pixels). Also referring to FIG. 6B, in order to identify connected components, either rows or columns may be swept to find like pixels that are side-by-side. The current illustration performs a row analysis, but differing embodiments of the invention support row or column analysis as well as database type analysis where pixels are evaluated without respect to row or column placement.

Referring again to FIG. 6B, when two sequential black pixels are encountered, we can identify a line segment containing those pixels. In some embodiments, N consecutive black pixels may be identified before a line segment is associated (e.g., after finding the first black pixel, the process can continue sweeping along a row until a white pixel is found and then declare the end of the particular black segment in that row). When a line segment is found, the data structure 602 can reflect the line segment (LineSegment 0) as shown in the first data-bearing row of the data structure 602. The record of the line segment (the vector components y, xL, xR, cc, next) bear the following information: row (y), referring to the row identity within the pixels 605; starting horizontal position (xL), referring to the position of the left most pixel in the segment; ending horizontal position (xR), referring to the right most pixel in the segment; parent connected component (cc), referring to the identity of the connected component in which the line segment belongs; and index of next line segment (next), referring to a relationship with other line segments in the same connected component. As shown in FIG. 6B, a first line segment has been identified (shown in green and surrounded by a dotted line red box). For purposes of this illustration, this line segment is a first connected component, which is identified in data structure 601 as connected component 0. The line segment is identified in the data structure 602 as the 0^{th} (y) row, starting at column 2 on the left (xL), ending at column 3 on the right (xR), belonging to connected component 0 (cc), and having nil related segments (next).

Referring to FIG. 6C, if the pixels 605 are further investigated along row 0, then another set of connected pixels will be found as shown in green and surrounded by the red dotted line box. This next black line segment may be identified as LineSegment 1 in the data structure 602. Another connected component is created for the new line segment and labeled connected component 1 in the data structure 601. Note that since the two line segments 0 and 1 are in the same row (and separated by a white pixel), at the current point in the analysis, they are assumed to be part of different connected components.

Referring to FIG. 6D, if the pixels 605 are further investigated along row 0, then another set of connected pixels will be found as shown in green and surrounded by the red dotted line box. This next black line segment may be identified as LineSegment 2 in the data structure 602. Another connected component is created for the new line segment 2 and labeled connected component 2 in the data structure 601. Again, note that since the three line segments 0, 1, and 2 are in the same row (and separated by white pixels), at the current point in the analysis, they are assumed to be part of different connected components.

Referring now to FIG. 6E, row 1 (the second row) is now investigated and it is noted that, since there are adjacent rows, any line segments found on row 1 may have connected components on adjacent rows. Any previously created/recorded line segments may be investigated for a relationship with any new-found line segment. Varying embodiments of the disclosure contemplate differing ways to perform this investigation, although the following examples are specifically envisioned at the current time.

Referring to FIG. 6E, a new line segment in row 1 may be found (shown as green pixels in the red dotted line box). The new line segment may be reflected in data structure 602 as line segment 3, shown in FIG. 6E. One way to determine if line segment 3 is related to other detected line segments is to search through all previously created line segments, in which case the program will find a relationship to line segment 0 based upon the fact that both exist in adjacent rows (0 and 1) and adjacent columns (2 and 3). In another embodiment for finding related line segments, a search is made through only line segments on adjacent rows. The case of the example from FIG. 6E (investigating the connected component in green and surrounded by red dotted line) shows that only row 0 can be searched because it is the only row that is reflected in the data structures and adjacent to the segment under consideration (shown in green and surrounded by a red dotted line).

Yet a third embodiment for finding related line segments involves keeping track of line segments in each row. For example, in these embodiments, all line segments are created in order from left to right and top to bottom. In other words, pixels are swept within rows from left to right and rows are investigated from top to bottom. Thus, referring to FIG. 6E, we may be looking for connected line segments for the line 1 segment in green surrounded by a red dotted line (the “current segment”). When the line above (line 0) is searched for segments from left to right, a line segment directly above the current segment (segment A is above the current segment) will be located as the first line segment to be checked in line 0. The program may then continue from left to right in line 0 starting after the segment directly above the current segment (i.e., everything to the left of segment A may be disregarded because segment A has already been investigated for its relationship to the current segment). As shown in FIG. 6E, the program will find the next segment in line zero (segment B), but this segment will not be connected to the current segment. Given that this segment is not connected to the current segment, there is no need to search further to the right in line 0, thus all connected segments for the current segment may be found by searching only two segments for the adjacent line (segment A and segment B). Similarly, referring to FIG. 6F, when the current segment (shown in green and bounded in a red dotted line) moves further to the right in line 1, there is no need to check segments in an adjacent line that are further to the left than where the analysis left off on the last search. In other words, there is no need to check Segment A. The program may then begin searching at segment B, and search no further after segment C (because segment C is not connected to the current segment). Referring again to FIG. 6E, when a connected neighbor is found, the new line segment may be added to data structure 602, which reflects both that the two line segments (0 and 3) are part of the same connected component (0) and that they are related segments (i.e., the “next” field of segment 3 shows a reference to segment 0).

Referring again to FIG. 6F, it is noted that the curved arrows to the right of data structure 602 are shown to conceptually connect the segments that are part of the same connected component.

Referring now to FIG. 6G, there is shown that the current segment (in green and bounded by a red dotted line) is connected to two segments above. The current segment may be identified in data structure 602 as segment 5, but, as shown in FIG. 6H, some of the connected components may be consolidated, thus eliminating connected component 1 in our example (i.e., in some embodiments, the consolidation is with the oldest connected component and the newer duplicative component is eliminated).

In some embodiments, when adding a line segment to a connected component, the program may update and/or retain statistics for the connected component. In some embodiments, these statistics are retained or updated on the fly, meaning, for example, the work is performed during the program pass of the pixels 605. Examples of these statistical items are as follows:
the number of holes in the connected component;
the circumference of the connected component;
the bounding box of the connected component (e.g., examples of bounding boxes shown in FIGS. 7C and 8B);
the longest line segment in the connected component;
the number of pixels in the connected component; and
the number of line segments in the connected component.

In addition regarding the data structures 601 and 602, varying embodiments of the disclosure contemplate different data structures, although any suitable data structure may be used. In one embodiment, the line segment structure 601 is a form of run length encoding. In the same or potentially other embodiments, the connected component structure 601 references or holds the segments in a linked list.

Referring again to FIG. 4, after blobs are detected (e.g., a connected component builder is exercised), at 404 groups of blobs called sequences may be constructed. For example, multiple blobs may be merged to create a sequence, a blob and a sequence may be merged to create a sequence, or two sequences may be merged to create a sequence. In some embodiments, the purpose of grouping blobs is to create roughly horizontal sequences out of the blobs (e.g., connected components) found earlier. These sequences should correspond to text words or sentences, although no recognition may necessarily be applied to reach that conclusion. In one embodiment, a bottom up approach is used to group blobs. In this embodiment (described in terms of connected components instead of blobs), the program starts with a single blob or connected component and follows the following path.

The program finds the closest connected component of the same color that is directly right of the current connected component (by looking for the closest neighbor to the right, the program need only check a small subset of connected components for each merge, which makes the algorithm faster). The two components may be merged into a sequence if one or more (and in some embodiments all) of the following criteria are found. The two connected components are: roughly the same size; roughly horizontal (either with a larger frame of reference, such as the image, or only with respect to one another); roughly the same area; not too far away from each other compared to their size (e.g., beyond a threshold that may be derived based upon connected component size); and do not have more than two holes each. The formed sequences, for example, may represent words, where each connected component may represent a letter.

In some embodiments, the sequences may be merged with connected components or other sequences in much the same way by finding the closest neighboring connected component (or sequence) to the right until no further merges are available. Of course, when merging sequences, some embodiments deemphasize requirements regarding the same size and area due to the expected length differential in the horizontal dimension. Furthermore, as shown in FIGS. 7C and 8B, bounding boxes may be created and/or visualized about the connected components and sequences.

After a sequence is created, statistics may be calculated for the sequence such as:
mean connected component height;
mean connected component width;
mean space between connected components; and
mean fill degree (number of pixels in a connected component divided by its area).

The statistics may be used for further analysis. For example, in some embodiments, any connected components at the beginning or end of a sequence that do not have roughly the same statistics as those calculated for the sequence as a whole may be removed from the sequence. In some embodiments, the “sameness” may be calculated based upon thresholds that are either absolute or derived from the statistics of the sequence or characteristics of the pixels 605 as analyzed.

In some embodiments, the slant of a sequence is calculated. Furthermore, any connected components that do not belong to any sequence but are close to a sequence spatially, are evaluated regarding whether they might be either punctuation or a diacritic mark depending on their size, shape, position, and number of holes.

In other embodiments of blob grouping 404, a top-down approach may be used where the program starts with larger connections (instead of a single connected component) and works down to smaller components.

Referring again to FIG. 4, at 405 false sequences (those not actually containing text) are eliminated or minimized. Common examples of false sequences may be image portions that represent noisy textures, barcodes, rows of windows, etc. In some embodiments, false sequences are eliminated with statistics instead of glyph analysis (which may form other embodiments). For these embodiments that use statistics instead of glyph analysis, the following tests may be applied to minimize or eliminate false filters:

Consider eliminating sequences or connected components based upon the number of connected components that are within a sequence's bounding box, but do not belong to the sequence (the number perhaps subject to a threshold). In some embodiments, this test relates best to filtering out textures.

Consider eliminating sequences or connected components based upon whether the average width of the sequence is comparable to the width of the component (the difference perhaps subject to a threshold). In some embodiments, this test relates best to filtering out textures.

Consider eliminating sequences or connected components based upon a comparison of a connected component's height with the average height within the sequence (the difference perhaps subject to a threshold). In some embodiments, this test relates best to filtering out textures.

Consider eliminating sequences or connected components based upon horizontal overlap of sequences/components (the size of the overlap perhaps subject to a threshold). In some embodiments, this test relates best to filtering out textures.

Consider eliminating sequences or connected components based upon a comparison of vertical variance with the sequence slant (the difference perhaps subject to a threshold). In some embodiments, this test relates best to filtering out textures.

Consider eliminating sequences or connected components based on the amount of noise in the background of the sequence bounding box (the amount of noise perhaps subject to a threshold). In some embodiments, this test relates best to filtering out textures.

Consider eliminating sequences or connected components based upon the kurtosis of the histogram of the pixels belonging to all the connected components in a sequence (the sharpness of the peak perhaps subject to a threshold). In some embodiments, this test relates best to filtering out textures.

Consider eliminating sequences or connected components based upon the connected component fill degree (the fill degree perhaps subject to a threshold). In some embodiments, this test relates best to filtering out barcodes or rows of windows.

Consider eliminating sequences or connected components based upon how the connected component circumference compares to bounding box size (the difference perhaps subject to a threshold). In some embodiments, this test relates best to filtering out barcodes or rows of windows.

Consider eliminating sequences or connected components based upon how the connected component's or sequence's longest line segment compares to the bounding box (the size difference perhaps subject to a threshold). In some embodiments, this test relates best to filtering out barcodes or rows of windows.

Referring again to FIG. 4, at 406 (after eliminating sequences and connected components at 405), the remaining identified portions are determined to contain text.

Multiple Scales

Some embodiments of the disclosure apply the process of FIG. 4 to multiple scales of the same input image. These embodiments may improve the system's ability to detect both small and large text. According to these embodiments and depending upon the size of the input image, several downscaled images may be created for analysis. In some embodiments, the input image is downscaled by ½, ¼, ⅛, 1/16 (and so on) until enough downscaled images are created. Generally, the image may be downscaled until the resolution becomes too low to provide useful information.

The process of FIG. 4 may be applied to all the downscaled versions and the results from analysis of the different scales may be merged so an overall improved data set may be achieved. Obviously, the same sequence may be detected on multiple scales, so embodiments of the disclosure do not report multiple detections for the same sequence in the merged result. In one embodiment of the disclosure, merging may be performed as follows:

The process begins with the sequences from the original input image and moves downward in size so that the largest downscaled image (e.g., ½) is analyzed first and the smallest downscaled image is analyzed last.

An array is created to hold all merged sequences and, in some embodiments, all the sequences from the original image.

Starting with the largest downscaled image (e.g., the ½ scale image), the program loops through the identified sequences one-by-one and compares them to the sequences in the merged array (which at this point would only contain the sequences from the original image). If there is overlap in the bounding box for any of the sequences, the individual connected components of the overlapping sequences are also compared. If the program finds significant overlap between any of the connected components of the full-scale sequence and the downscaled sequence (e.g., the ½ scale sequence), the sequences are classified as having detected the same text in the image. The program then finds the sequence in the merged array that has the largest number of overlapping connected components and makes a determination whether to replace it with the ½ scale sequence. The ½ scale sequence may be chosen if it is wider and has at least 2 more connected components than the full scale sequence. If the ½ scale sequence is chosen, the program removes all sequences in the merged array that have overlapping connected components with the ½ scale sequence.

Once the program has run through all sequences in the largest downscaled image (e.g., the ½ scale image), the same process is performed for the next downscaled image (e.g., the ¼ scale image), at which point the program is comparing the merged array (which contains sequences from both the full scale image and the ½ scale image) with the sequences from ¼ scale image. This process is continued until the scaled versions have been merged.

The process of this embodiment ensures or protects from returning multiple sequences for the same text in the image. Some embodiments choose the widest sequence because a sequence detected as two words in one scale may often be detected as a sentence in another.

API

The disclosure above has discussed embodiments of the disclosure wherein a program interface may be used to access text detection described herein. The API form envisioned by many embodiments herein is similar to an API published by Apple called CIDetector, which is further described in the provisional application incorporated herein by reference (provisional application No. 62/172,117, filed Jun. 7, 2015). In summary, A CIDetector object uses image processing to search for and identify notable features (faces, rectangles, and barcodes) in a still image or video. Detected features are represented by CIFeature objects that provide more information about each feature. In some envisioned embodiments of the current disclosure, with respect to a text detector, it may be created by calling

### +(CIDetector*)detectorOfType:(NSString*)type

context:(CIContext*)context

options:(NSDictionary*)options

Where type is one of:

### NSString*const CIDetectorTypeFace

### NSString*const CIDetectorTypeRectangle

### NSString*const CIDetectorTypeQRCode

The newly added type will be

### NSString*const CIDetectorTypeText

Once an appropriate CIDetector is created, it may detect text in an image by calling either of

(NSArray*)featuresInImage:(CIImage*)image

(NSArray*)featuresInImage:(CIImage*)image
options: (NSDictionary*)options

In some embodiments, if any text is detected, the function will return an array of CITextFeature. By way of example CIFeature Class Reference is also part of the provisional application No. 62/172,117.

Some embodiments of this disclosure contemplate that CITextFeature has similar properties to the CIQRCodeFeature. In certain embodiments, CITextFeature has no messageString property. The CIQRCodeFeature Class Reference is also disclosed in provisional application No. 62/172,117.

As discussed above, embodiments of the disclosure employ a bounding box. A framework embodiment implementation of that concept is apparent in that CIText has a bounding box as follows:

@property(readonly, assign) CGRect bounds
And four corners
@property(readonly, assign) CGPoint bottomLeft
@property(readonly, assign) CGPoint bottomRight
@property(readonly, assign) CGPoint topLeft
@property(readonly, assign) CGPoint topRight

It is to be understood that the above description is intended to be illustrative, and not restrictive. The material has been presented to enable any person skilled in the art to make and use the invention as claimed and is provided in the context of particular embodiments, variations of which will be readily apparent to those skilled in the art (e.g., many of the disclosed embodiments may be used in combination with each other). In addition, it will be understood that some of the operations identified herein may be performed in different orders. The scope of the invention therefore should be determined with reference to the appended claims, along with the full scope of equivalents to which such claims are entitled. In the appended claims, the terms “including” and “in which” are used as the plain-English equivalents of the respective terms “comprising” and “wherein.”

1. A method comprising:
receiving a first version of image information;
categorizing each pixel of the first version of image information into one of a plurality of categories;
for one or more category of pixels, identifying one or more collections of pixels in the first version of image information, wherein a collection of pixels indicates a plurality of pixels that are continuously neighboring each other and are all within the same category of pixels;
identifying one or more sequences, each comprising a plurality of collections of pixels, wherein all the pixels in a sequence are within the same category of pixels, and wherein all the collections of pixels within a sequence are horizontally oriented with respect to one and other;
eliminating one or more sequences or collections of pixels based upon statistics regarding the one or more sequences or collections of pixels; and
determining, without performing glyph analysis for the first version of the image information, that sequences and collections of pixels that have not been eliminated comprise text.

2. The method of claim 1, wherein a collection of pixels may be a blob or a connected component.

3. The method of claim 1, wherein categorizing each pixel includes binarization.

4. The method of claim 1, wherein categorizing each pixel includes trinarization.

5. The method of claim 4, wherein trinarization comprises categorizing pixels as black, white, or gray; and wherein a pixel categorized as gray indicates that the pixel has been determined as not relating to text.

6. The method of claim 5, wherein categorizing pixels as black or white is based upon whether a pixel value is greater than or less than a black point or white point.

7. The method of claim 5, wherein categorizing a pixel as gray correlates with the contrast present in a region of the image in which the pixel is located.

8. The method of claim 1, wherein the received first version of image information is converted into a plurality of scaled versions, and wherein each scaled version is a representation of the received first version of image information applying a downscaling factor; and further comprising determining, for each scaled version, sequences that comprise text, and comparing the determined sequences of one scaled version to one or more determined sequences of another scaled version or one or more determined sequences of the first version.

9. The method of claim 1, wherein all collections of pixels are identified in one sweep through the pixels of the received first version of image information.

10. The method of claim 2, wherein one or more connected components are identified in a first row or first column of pixels of the received first version of image information; and wherein the one or more connected components are associated with another connected component identified in a second row or a second column.

11. The method of claim 1 wherein the received first version of image information is in the form of JPEG, GIF, or RAW.

12. A system comprising:
one or more CPUs;
one or more cameras for capturing images represented as image information;
a memory for storing program instructions for the one or more CPUs, where the instructions, when executed, cause the one or more CPUs to:
receive a first version of image information;
categorize each pixel of the first version of image information into one of a plurality of categories;
for one or more category of pixels, identify one or more collections of pixels in the first version of image information, wherein a collection of pixels indicates a plurality of pixels that are continuously neighboring each other and are all within the same category of pixels;
identify one or more sequences, each comprising a plurality of collections of pixels, wherein all the pixels in a sequence are within the same category of pixels, and wherein all the collections of pixels within a sequence are horizontally oriented with respect to one and other;
eliminate one or more sequences or collections of pixels, the elimination based upon statistics regarding the one or more sequences or collections of pixels; and
determine that sequences and collections of pixels that have not been eliminated comprise text.

13. The system of claim 12, wherein the instructions that cause the one or more CPUs to categorize comprise instructions that cause the one or more CPUs to trinarize each pixel.

14. The system of claim 13, wherein the instructions that cause the one or more CPUs to trinarize each pixel comprises instructions that cause the one or more CPUs to categorize pixels as black, white, or gray; and wherein a pixel categorized as gray indicates that the pixel has been determined as not relating to text.

15. The system of claim 12, wherein the instructions, when executed, further cause the one or more CPUs to:
convert the received first version of image information into a plurality of scaled versions, wherein each scaled version is a representation of the received first version of image information applying a downscaling factor;
determine, for each scaled version, sequences that comprise text; and
compare the determined sequences of one scaled version to one or more determined sequences of another scaled version or one or more determined sequences of the first version.

16. A non-transitory computer readable medium comprising one or more instructions that, when executed, configure a processor to:
receive a first version of image information;
categorize each pixel of the first version of image information into one of a plurality of categories;
for one or more category of pixels, identify one or more collections of pixels in the first version of image information, wherein a collection of pixels indicates a plurality of pixels that are continuously neighboring each other and are all within the same category of pixels;
identify one or more sequences, each comprising a plurality of collections of pixels, wherein all the pixels in a sequence are within the same category of pixels, and wherein all the collections of pixels within a sequence are horizontally oriented with respect to one and other;
eliminate one or more sequences or collections of pixels, the elimination based upon statistics regarding the one or more sequences or collections of pixels; and
determine that sequences and collections of pixels that have not been eliminated comprise text.

17. The non-transitory computer readable medium of claim 16, wherein the instructions that configure a processor to categorize comprise instructions that configure the processor to trinarize each pixel.

18. The non-transitory computer readable medium of claim 16, wherein the instructions, when executed, further configure the processor to:
convert the received first version of image information into a plurality of scaled versions, wherein each scaled version is a representation of the received first version of image information applying a downscaling factor;
determine, for each scaled version, sequences that comprise text; and
compare the determined sequences of one scaled version to one or more determined sequences of another scaled version or one or more determined sequences of the first version.

19. The non-transitory computer readable medium of claim 16, wherein a collection of pixels may be a blob or a connected component.

20. The non-transitory computer readable medium of claim 19, wherein the instructions, when executed, further configure the processor to:
identify one or more connected components in a first row or first column of pixels of the received first version of image information; and
associate the one or more connected components with another connected component identified in a second row or a second column.
